(19) United States
(12) Patent Application Publication
(10) Pub. No.: US 2017/0003386 A1
(43) Pub. Date: Jan. 5, 2017

(54) MEASUREMENT OF DISTANCE BETWEEN DEVICES USING AUDIO SIGNALS

(71) Applicant: INTEL CORPORATION, Santa Clara, CA (US)

(72) Inventors: KIRILL YURKOV, Saint-Petersburg (RU); MIKHAIL LYAKH, St. Petersburg (RU)

(21) Appl. No.: 15/125,685

(22) PCT Filed: May 29, 2014
(86) PCT No.: PCT/IB2014/001648

§ 371 Date: Sep. 13, 2016

(51) Int. Cl. G01S 11/14; H04R 3/00; H04R 3/04

(52) U.S. Cl. CPC G01S 11/14; H04R 3/04; H04R 3/005; H04R 2420/07; H04R 2430/20

(57) ABSTRACT

Audio signals may be used for distance measurement with good autocorrelation properties which provides for the possibility of sub-sample delay measurement. Continuous playback and recording by all devices during the distance measurement process (including recording of the own playback) allows exclusion of random start/stop delays and subsequent large random errors.

### BACKGROUND

This relates to the use of microphone arrays to facilitate tasks such as teleconferencing, voice control, and speech recognition.

A microphone array may be composed of multiple microphones in a fixed arrangement that collect relatively high quality sound from a number of sources. Quality may be enhanced by using time differences between various sounds and estimating the locations of the sound sources as well as by separating the various different sources. For example, the microphones may be placed in permanent locations along a wall or ceiling. In order to obtain high quality sound from multiple sources, it is necessary to suppress the adverse effects or reflections, reverberations and multiple sound sources.

The microphone array may include the microphones in several independent mobile devices. Distances between devices may be measured using their microphones and loudspeakers. Currently mobile devices have limited possibilities for their time synchronization and consequently aligning their recorded tracks. A second issue is random delays of starting both record and playback on devices.

### BRIEF DESCRIPTION OF THE DRAWINGS

Some embodiments are described with respect to the following figures:

FIG. 1 is a schematic depiction for one embodiment;

FIG. 2 is an autocorrelation function for one embodiment;

FIG. 3 is schematic depiction of the pilot signal detector of FIG. 1 for one embodiment;

FIG. 4 is a flow chart for one embodiment;

FIG. 5 shows recording and playback for three devices according to one embodiment;

FIG. 6 is a system depiction for one embodiment; and

FIG. 7 is a front elevational view for one embodiment.

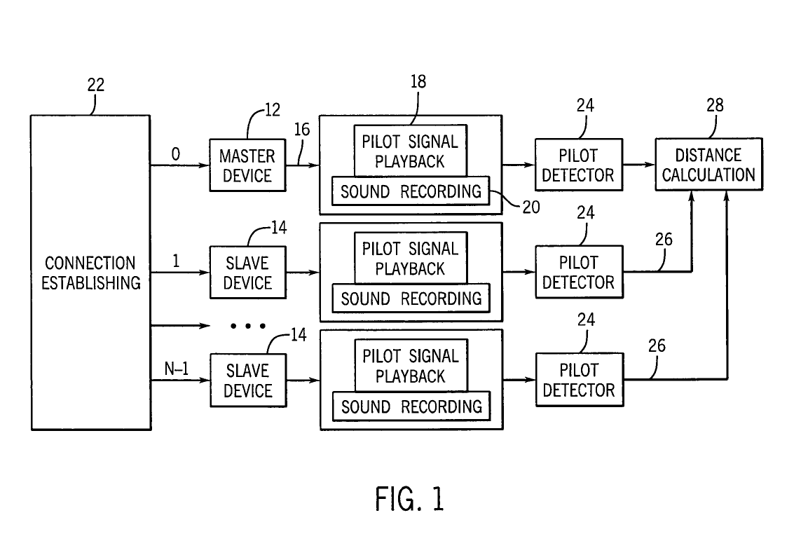

### DETAILED DESCRIPTION

Audio signals may be used for distance measurement with good autocorrelation properties which provides for the possibility of sub-sample delay measurement. Continuous playback and recording by all devices during the distance measurement process (including recording of their own playback) allows exclusion of random start/stop delays and subsequent large random errors.

The devices in question include mobile computing devices such as laptop computers, cellular telephones or gaming devices, to mention a few examples, connected together over suitable network. The network may be a wired or wireless network. Commands may be issued from one device to other devices in the network in order to play pilot signals that are recorded and then used for determining the distances between the various devices. The distances between the various devices may be used for a variety of purposes including but not limited to improving the quality of the sound produced by an array of microphones in an array of different devices. The distance measurements may also be useful in other applications including interference mitigation, device location and network configuration to mention a few examples.

Thus in many cases the computer device may have one or more microphones and one or more loudspeakers. The existing microphones and loud-speakers may be used for the additional purposes described herein.

Assuming N devices whose relative distances are to be defined, each device has a microphone and a loudspeaker in one embodiment. The distance between devices i and j is l_{i,j}, i, j ∈0:N−1. Denote as l_{if}, the distance between a microphone and a loudspeaker on device i. Assume that lᵢⱼ=Vlⱼᵢ, ∀i,j. The devices do not have time synchronization and their microphones and loudspeakers have unknown latencies between start/stop commands and their real execution.

The distance calculation between devices may be as follows in one embodiment. The devices (master 12 and slave 14) establish a connection 22 through WiFi, Bluetooth or other wired or wireless protocol. The connection may be a network connection. They choose a master device 12 which will send control commands to slaves 14. The communications to select a master and send control commands may be wired or wireless commands over a network for example including a wired or wireless network. The master device sends a command 16 to synchronize play of pilot signals by audio playback 18 in all of the devices and to synchronize recording by sound recording 20. In one embodiment, the pilot signals may then be played at the same time by each device.

Each device generates its own pilot signal and starts both playing its pilot signal and recording the audio pilot signals of all devices, including its own pilot signal. Each device detects, in pilot detector 24, positions of N pilot signals in its recorded samples. Each slave device sends (block 26) the information about measured delays to the master device. The master device calculator 28 calculates the distances between the devices and then sends the distances to all devices if it is necessary. The recording of its own audio pilot signal may be used by a device to assess its own internal latency.

The pilot signals may be any audio signal used for synchronization or references purposes and may include a series of spikes at regular intervals, called pilot periods. Typically a pilot signal has wide audio frequency range in one embodiment.

For given parameters F, f₀, n, the pilot signal for device k is defined as:

$${x}_{k} ( t ) = \{ \begin{matrix}p ( t - k ( {T}_{0} + {T}_{1} ) ) , & t ∈ k ( {T}_{0} + {T}_{1} ) \text{:} k ( {T}_{0} + {T}_{1} ) + {T}_{0} \\ 0 , & otherwise\end{matrix} ,$$

where T₀ is the duration of the pilot signal, T₁ is duration the silence between pilots of adjacent devices, and p(t) is pseudorandom sequence defined by Shapiro polynomials. These polynomials can be defined in a recursive way as:

P₀ (z)=1, Q₀(z)=1; Pₙ₊₁(z)=Pₙ(z)+z²ⁿQₙ(z); Qₙ₊₁(z)=Pₙ(z)−z²ⁿQₙ(z).

The coefficients of polynomial Pₙ(z) and Qₙ(z) are from the set (1,−1). The i-th coefficient in a corresponding polynomial is defined as P_{n,i} and Q_{n,i}. These coefficients define pseudorandom phase switching in the pseudorandom signal p(t).

The modulation sequence is:

$$m ( i ) = \{ \begin{matrix}{P}_{n , i} , i \leq {2}^{n - 1} \\ 0 , i ∈ {2}^{n - 1} + 1 \text{:} {2}^{n} \\ {Q}_{n , i - {2}^{n}} i > {2}^{n}\end{matrix}$$

Finally to construct p(t), the signal which will be modulated by the modulator sequence m(i) is introduced. Let Φ

$$( k ) = sin \frac{2 π {f}_{0} k}{F} ,$$

where f₀ is the carrier frequency and F is the sampling frequency. Now letting

$$N = ⌊ \frac{F}{2 {f}_{0}} ⌋$$

and supposing that t=iN+k, k<N, then p(t)=m(i)Φ(k).

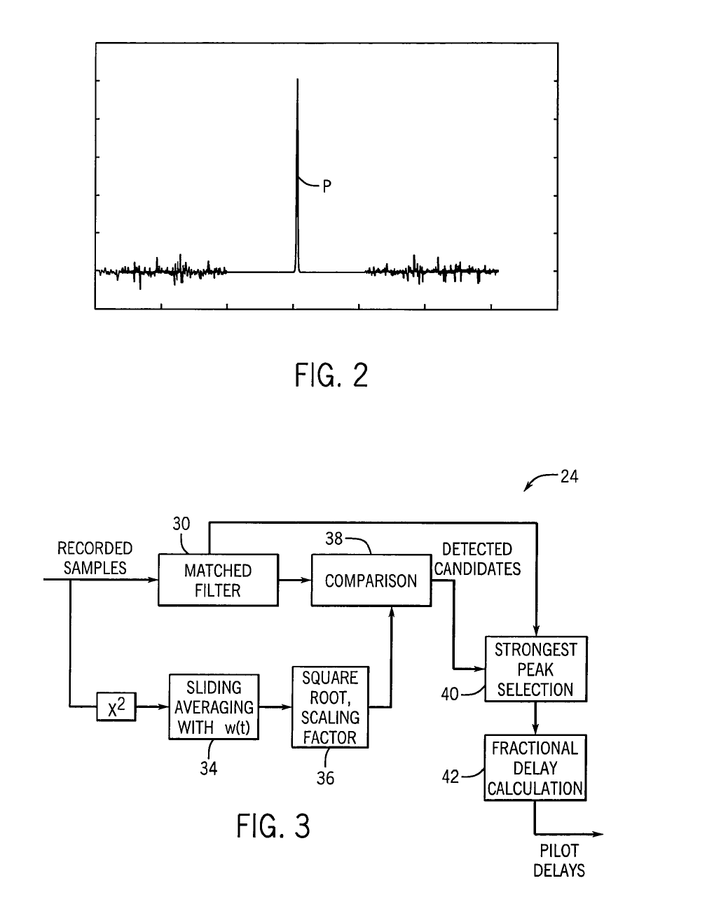

The main property of the pseudorandom sequence p(t) that is useful in an attack detection procedure is its autocorrelation shape. Autocorrelation is the cross-correlation of a signal with itself. A typical autocorrelation for p(t) is given in FIG. 2 with F=44100 f₀=11025 and n=9. The main peak P at the center is surrounded by zeros so that the signal response can be distinguished from noise.

A pilot detector 24, shown in FIG. 3, finds delays between pilot signals in the recorded samples. An adaptive matched filter detection algorithm is shown in FIG. 3. The algorithm shown in FIG. 3 may be implemented in software, firmware and/or hardware. In software and firmware embodiments it may be implemented by computer executed instructions stored in one or more non-transitory computer readable media such as magnetic, optical, or semiconductor storages. For example it may be implemented in a storage associated with a processor in one embodiment.

The pilot detector 24 calculates a correlation c(t) of the recorded samples with the pseudorandom sequence p(t) using a matched filter 30 and average signal power s(t) in the sliding window w(r) 34:

$$w ( τ ) = \{ \begin{matrix}1 , 0 < τ \leq {2}^{n} N , and 2 N {2}^{n} < τ \leq 3 N {2}^{n} \\ 0 , otherwise\end{matrix}$$

The sliding averaging receives the square (x²) of the received signal. Note that w(τ) is nonzero where corresponding parts of p(t) are modulated. The pilot detection decision is taken if c(t) is larger than an adaptive threshold A(t) calculated as Δ(t)=K\sqrt{s(t)} at block 36, where scaling factor K directly governs the false alarm probability and can be approximated as:

$$K = {( \frac{P}{2 N {2}^{n}} )}^{1 / {2}_{Q - 1 ( {P}_{fa} )}}$$

where P is total energy of p(t), Q⁻¹ is an inverse Q-function, and P_{fa} is false alarm probability per sample. A comparison at block 38 identifies detected candidates from the filter 30 input with c(t) larger than the adopted threshold from block 36.

Detected candidates' peaks can be further filtered in order to exclude close peaks due to multipath signal propagation. Only the strongest peak is selected at block 40 in the given observation window. The duration of the observation window may be selected to be less than pilot period (e.g. a half the pilot period). To increase precision of the distance measurement, the fractional delay Δt may be estimated at block 42 using an approximation of the matched filter output in the vicinity of the strongest peak. For instance, a parabolic approximation gives:

$$Δ t = \frac{c ( {t}^{*} + 1 ) - c ( {t}^{*} - 1 )}{2 ( c ( {t}^{*} + 1 ) + c ( {t}^{*} - 1 ) - 2 c ( {t}^{*} ) )}$$

where t* is the integer index of the strongest peak.

In one embodiment, this signal detecting method also allows synchronizing audio recorded tracks between several devices using only playback of a pilot signal on one device. Other devices can find the positions of recorded pilots and align the recorded track, taking into account the distances between devices. This may be useful for smart multiple microphone array processing in some embodiments.

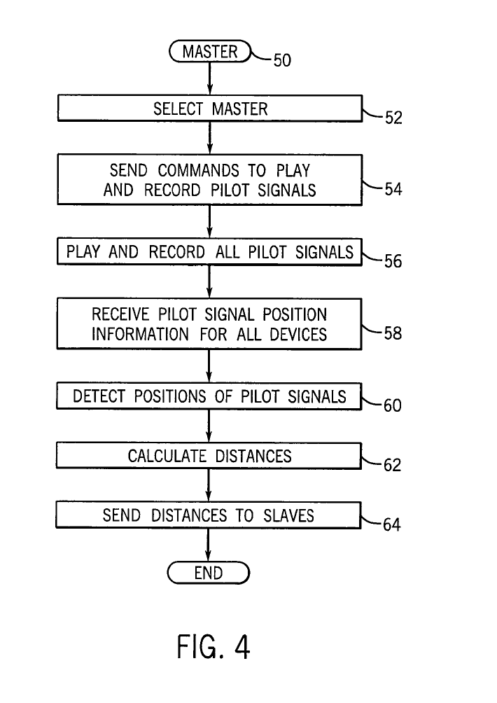

An algorithm shown in FIG. 4 may be implemented in software, firmware and/or hardware. In software and firmware embodiments it may be implemented by computer executed instructions stored in one or more non-transitory computer readable media such as magnetic, optical, or semiconductor storages. For example it may be implemented in a storage associated with a processor in one embodiment.

The sequence 50, shown in FIG. 4, is a sequence for a master device. The sequence corresponds to the sequence for a slave device, the differences being that the slave device receives the commands to play and record and sends the results to the master. The sequence begins by selecting a master as indicated in block 52. The master selection may be a conventional sequence used in various wireless protocols for example. Then the master sends the commands to play and record the pilot signals as indicated in block 54. This results in synchronized play and record.

The master also plays and records its own pilot signal in response to a command to itself as indicated in block 56. Then in block 58, the master receives pilot signal position information from the slaves and from its own recording device. Then the master detects the positions of its own pilot signals as indicated in block 60. Next the master calculates the distances as indicated in block 62. Finally the master sends the calculated distances to the slaves as indicated in block 64.

The delay inherent in audio playback of device k is defined as Δₖ. The recording delay of device k is defined as δₖ, k ∈0:N−1. The pilot delay detected by device k for recording the device m is defined as bₖₘ. The delays Δₖ, δₖ are caused both by an absence of time synchronization between devices and the random lag between sending the commands to play and record and execution of those commands for microphone and recorder on each device.

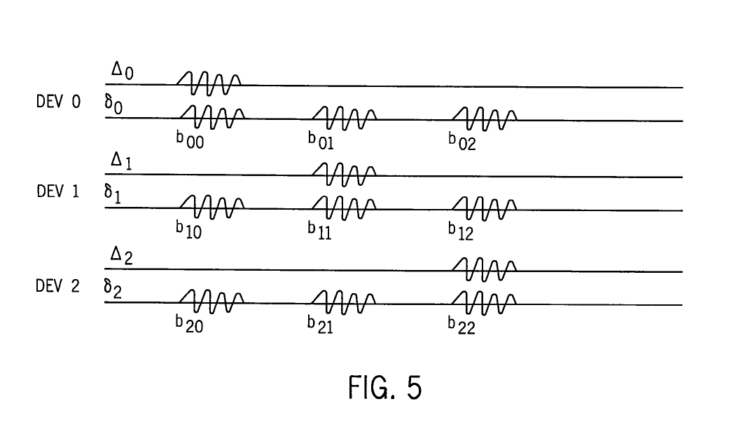

FIG. 5 shows hypothetical Δₖ and δₖ for three devices, DEV0, DEV1, and DEV2. For example DEV0 has pilot delay b₀₀ between its own generated pilot and the recording of that pilot signal. It detects a delay b₀₁ between its own pilot signal and a pilot signal of DEV1.

The following equations hold:

$$\{ \begin{matrix}{b}_{km} = {Δ}_{m} - {δ}_{k} + m ( {T}_{0} + {T}_{1} ) + {l}_{km} \cdot F / {c}_{s} , & ∀ {k}_{m} ∈ 0 \text{:} N - 1 \\ {l}_{km} = {l}_{mk} , & ∀ k , m ∈ 0 \text{:} N - 1\end{matrix} .$$

Here cₛ is the speed of sound. Simple calculations give:

$${l}_{km} = \frac{{l}_{kk} + {l}_{mm} + [ ( {b}_{mk} - {b}_{kk} ) + ( {b}_{km} - {b}_{mm} ) ] \cdot {c}_{s} \text{/} F}{2}$$

Thus, if delays Δₖ and δₖ are constant for each pilot delay measurement and that constancy can be achieved by continuous playback/recording, then the unknown delays are excluded in the formula for the distances.

The processing techniques described herein may be implemented in various hardware architectures. For example, the functionality may be integrated within a chipset. Alternatively, a discrete processor may be used. As still another embodiment, the functions may be implemented by a general purpose processor, including a multicore processor.

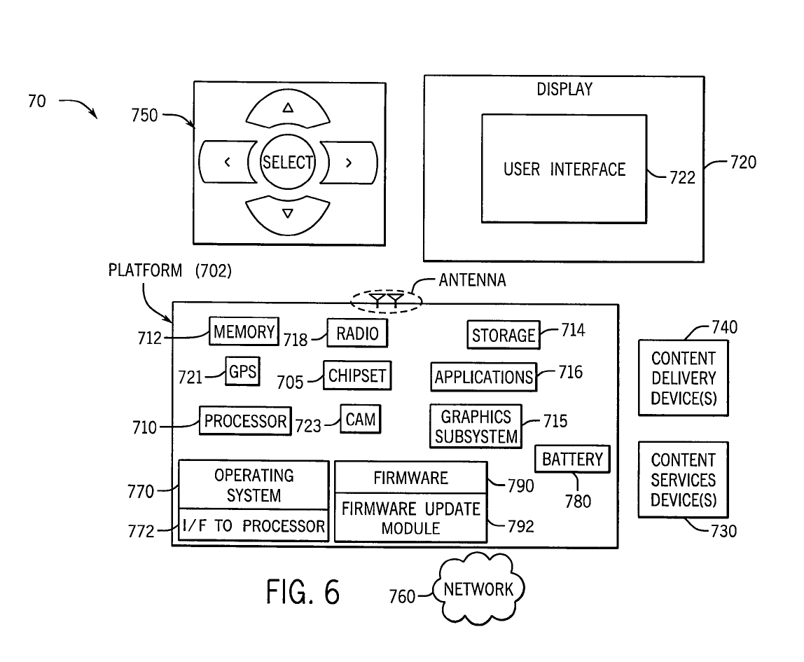

FIG. 6 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, ×86 instruction set compatible processors, multi-core, or any other microprocessor or central processing unit (CPU). In embodiments, processor 710 may comprise dual-core processor(s), dual-core mobile processor(s), and so forth. The processor may implement the sequence of FIG. 4 together with memory 712.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WLANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit the applicable embodiments.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to be scope limiting.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

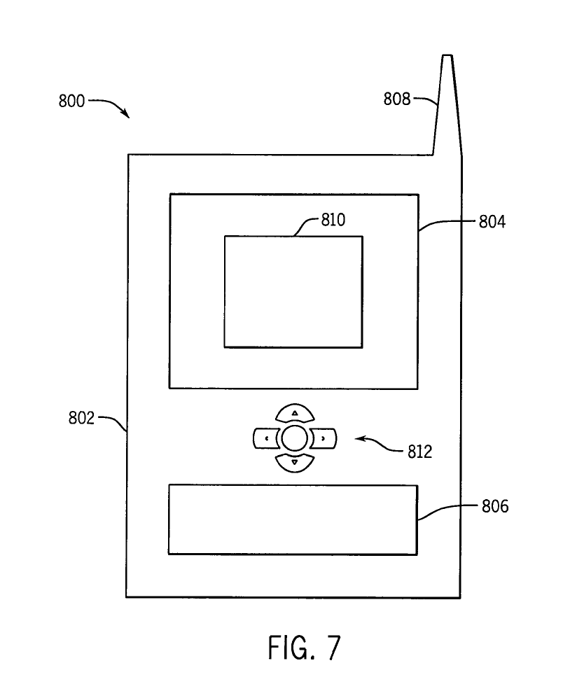

As described above, system 700 may be embodied in varying physical styles or form factors. FIG. 7 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The following clauses and/or examples pertain to further embodiments:

One example embodiment may be a method comprising causing two devices to play a pilot signal in synchronism with one another, causing each device to record pilot signals being played, measuring the delays between the recorded pilot signals and using the measured delays to calculate a distance between the two devices. The method may also include choosing a master among a plurality of devices. The may also include causing the master to send a signal to the other devices to play a pilot signal. The method may also include causing each of a plurality of devices to measure the delay between pilot signals and send the delay measurement to the master. The method may also include causing the master to calculate the distances between devices. The method may also include sending the distances to each of said devices. The method may also include using an adaptive matched filter algorithm to calculate a correlation of a recorded pilot signal and a pseudorandom sequence defined by Shapiro polynomials. The method may also include calculating the correlation using a matched filter and average signal power in a sliding window. The method may also include detecting a pilot signal if the correlation is larger than an adaptive threshold. The method may also include calculating said adaptive threshold as the square root of the average signal power times a scaling factor representing the probability of a false alarm.

Another example embodiment may be one or more non-transitory computer readable media storing instructions for execution by a processor to perform a sequence comprising causing two devices to play a pilot signal in synchronism with one another, causing each device to record both pilot signals being played, measuring the delays between the recorded pilot signals, and using the measured delays to calculate a distance between the devices. The media of said sequence may include choosing a master among a plurality of devices. The media of said sequence may include causing the master to send a signal to the other device to play a pilot signal. The media of said sequence may include causing each of a plurality of devices to measure the delay and send the delay measurement to the master. The media of said sequence may include causing the master to calculate the distances between devices. The media of said sequence may include sending the distances to each of said devices. The media of said sequence may include using an adaptive matched filter algorithm to calculate a correlation of a recorded pilot signal and a pseudorandom sequence defined by Shapiro polynomials. The media of said sequence may include calculating the correlation using a matched filter and average signal power in a sliding window.

In another example embodiment an apparatus comprising a pilot signal playback device, a sound recording device to record a pilot signal, a pilot signal detector; and a distance calculator to measure a delay between detected pilot signals and to use the measured delay to calculate a distance between the apparatus and another apparatus. The apparatus may include a transmitter to send a wireless signal to another device to play a pilot signal. The apparatus may include an adaptive matched filter to calculate a correlation of a recorded signal and a pseudorandom sequence defined by Shapiro polynomials. The apparatus may include said filter to calculate the correlation using a matched filter and average signal power in a sliding window. The apparatus may include said pilot signal detector to detect a pilot if the correlation is larger than an adaptive threshold. The apparatus may include said calculator to calculate said adaptive threshold as the square root of the average signal power times a scaling factor representing the probability of a false alarm. The apparatus may include a battery. The apparatus may include firmware and a module to update said firmware.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
causing two devices to play a pilot signal in synchronism with one another;
causing each device to record pilot signals being played;
measuring the delays between the recorded pilot signals; and
using the measured delays to calculate a distance between the two devices.

2. The method of claim 1 including choosing a master among a plurality of devices.

3. The method of claim 2 including causing the master to send a signal to the other devices to play a pilot signal.

4. The method of claim 3 including causing each of a plurality of devices to measure the delay between pilot signal playback and send the delay measurement to the master.

5. The method of claim 4 including causing the master to calculate the distances between devices.

6. The method of claim 5 including sending the distances to each of said devices.

7. The method of claim 1 including using an adaptive matched filter algorithm to calculate a correlation of a recorded pilot signal and a pseudorandom sequence defined by Shapiro polynomials.

8. The method of claim 7 including calculating the correlation using a matched filter and average signal power in a sliding window.

9. The method of claim 8 including detecting a pilot signal if the correlation is larger than an adaptive threshold.

10. The method of claim 9 including calculating said adaptive threshold as the square root of the average signal power times a scaling factor representing the probability of a false alarm.

11. One or more non-transitory computer readable media storing instructions for execution by a processor to perform a sequence comprising:
causing two devices to play a pilot signal in synchronism with one another;
causing each device to record both pilot signals being played;
measuring the delays between the recorded pilot signals; and
using the measured delays to calculate a distance between the devices.

12. The media of claim 11, said sequence including choosing a master among a plurality of devices.

13. The media of claim 12, said sequence including causing the master to send a signal to the other device to play a pilot signal.

14. The media of claim 13, said sequence including causing each of a plurality of devices to measure the delay and send the delay measurement to the master.

15. The media of claim 14, said sequence including causing the master to calculate the distances between devices.

16. The media of claim 15, said sequence including sending the distances to each of said devices.

17. The media of claim 11, said sequence including using an adaptive matched filter algorithm to calculate a correlation of a recorded pilot signal and a pseudorandom sequence defined by Shapiro polynomials.

18. The media of claim 17, said sequence including calculating the correlation using a matched filter and average signal power in a sliding window.

19. An apparatus comprising:
a pilot signal playback device;
a sound recording device to record a pilot signal;
a pilot signal detector; and
a distance calculator to measure a delay between detected pilot signals and to use the measured delay to calculate a distance between the apparatus and another apparatus.

20. The apparatus of claim 19, a transmitter to send a wireless signal to another device to play a pilot signal.

21. The apparatus of claim 19 including an adaptive matched filter to calculate a correlation of a recorded signal and a pseudorandom sequence defined by Shapiro polynomials.

22. The apparatus of claim 21 said filter to calculate the correlation using a matched filter and average signal power in a sliding window.

23. The apparatus of claim 22 said pilot signal detector to detect a pilot if the correlation is larger than an adaptive threshold.

24. The apparatus of claim 19 said calculator to calculate said adaptive threshold as the square root of the average signal power times a scaling factor representing the probability of a false alarm.

25. The apparatus of claim 19 including a battery.

26. The apparatus of claim 19 including firmware and a module to update said firmware.
